(19) United States
(12) Patent Application Publication
(10) Pub. No.: US 2025/0210656 A1
(43) Pub. Date: Jun. 26, 2025

(54) ELECTRODE ACTIVE MATERIAL AND MANUFACTURING METHOD THEREFOR, ELECTRODE MIXTURE, AND BATTERY

(71) Applicant: TOYOTA JIDOSHA KABUSHIKI KAISHA, Aichi-ken (JP)

(72) Inventors: Hidetaka NISHIKOORI, Shizuoka-ken (JP); Hideyuki YAMAMURA, Shizuoka-ken (JP)

(21) Appl. No.: 19/000,699

(22) Filed: Dec. 24, 2024

(30) Foreign Application Priority Data
Dec. 26, 2023 (JP) 2023-219980

(51) Int. Cl. H01M 4/583; H01M 4/02; H01M 4/04; H01M 10/054

(52) U.S. Cl. CPC H01M 4/583; H01M 4/0471; H01M 10/054; H01M 2004/027

(57) ABSTRACT

The present disclosure provides an electrode active material comprising hard carbon and capable of improving capacity at low potential and a manufacturing method therefor, an electrode mixture comprising such an electrode active material, and a battery comprising such an electrode mixture. The hard carbon comprised in the electrode active material of the present disclosure has a G′-band, a G-band, and a D-band in a Raman spectrum. The ratio I_{G′}/I_{G} of intensity I_{G}, of the G′-band to intensity I_{G} of the G-band is 0.05 or more. The half-width Hw_{D} of D-band is 50 or more and 160 or less. The method for manufacturing the electrode active material of the present disclosure comprises the following steps: providing a raw material comprising carbon, and firing to carbonize the raw material under an inert atmosphere comprising more than 0% and less than 1.0% of air.

### FIELD

The present disclosure relates to an electrode active material and a manufacturing method therefor, an electrode mixture, and a battery.

### BACKGROUND

As disclosed in PTL 1 and 2, batteries comprising hard carbon as a negative electrode active material have been developed.

### CITATION LIST

### Patent Literature

[PTL 1]. International Publication WO 2012/147242
[PTL 2]. Japanese Unexamined PCT Publication (Kokai) No. 2021-012872

### SUMMARY

### Technical Problem

There is room for improvement in capacity at low potential in batteries comprising hard carbon as an electrode active material.

It is an object of the present disclosure to provide an electrode active material comprising hard carbon and capable of improving capacity at low potential and a manufacturing method therefor, an electrode mixture comprising such an electrode active material, and a battery comprising such an electrode mixture.

### Solution to Problem

The present disclosure have found that the above-mentioned problem could be solved by the following means.

### <Aspect 1>

An electrode active material comprising hard carbon,
wherein the hard carbon has a G′-band, a G-band, and a D-band in a Raman spectrum,
wherein a ratio I_{G′}/I_{G} of intensity I_{G}, of the G′-band to intensity I_{G} of the G-band is 0.05 or more, and
wherein a half-width Hw_{D} of the D-band is 50 or more and 160 or less.

### <Aspect 2>

The electrode active material according to Aspect 1, wherein the half-width Hw_{D} of the D-band is 90 or more and 130 or less.

### <Aspect 3>

The electrode active material according to Aspect 1 or 2, wherein the ratio I_{D}/I_{G} of intensity I_{D} of the D-band to intensity I_{G} of the G-band is 1.0 or more and 1.6 or less.

### <Aspect 4>

The electrode active material according to Aspect 3, wherein the ratio I_{D}/I_{G} of intensity I_{D} of the D-band to intensity I_{G} of the G-band is 1.2 or more and 1.4 or less.

### <Aspect 5>

An electrode mixture comprising the electrode active material according to any one of Aspects 1 to 4.

### <Aspect 6>

A battery,
wherein the battery comprises a negative electrode current collector layer, a negative electrode active material layer, an electrolyte layer, a positive electrode active material layer, and a positive electrode current collector layer in this order,
wherein either one of the negative electrode active material layer and the positive electrode active material layer comprises the electrode mixture according to Aspect 5.

### <Aspect 7>

The battery according to Aspect 6, wherein the negative electrode active material layer comprises the electrode mixture according to Aspect 5.

### <Aspect 8>

The battery according to Aspect 6 or 7, wherein the battery is a sodium ion battery in which the electrolyte layer has a sodium ion.

### <Aspect 9>

The battery according to Aspect 8, wherein the battery is a liquid-based battery in which the electrolyte layer comprises an electrolytic solution having a sodium ion.

### <Aspect 10>

The battery according to Aspect 8, wherein the battery is a solid-state battery in which the electrolyte layer comprises a solid electrolyte having a sodium ion.

### <Aspect 11>

A method for manufacturing an electrode active material according to any one of Aspects 1 to 4, comprising the following steps:
providing a raw material comprising carbon, and
firing to carbonize the raw material under an inert atmosphere comprising more than 0% and less than 1.0% of air.

### Advantageous Effects of Invention

According to the present disclosure, it is possible to provide an electrode active material comprising hard carbon and capable of improving capacity at low potential and a manufacturing method therefor, an electrode mixture comprising such an electrode active material, and a battery comprising such an electrode mixture.

### BRIEF DESCRIPTION OF DRAWINGS

FIG. 1 is a schematic cross-sectional view showing an example of a battery of the present disclosure.

FIG. 2 is a Raman spectrum of the electrode active material of Example 1.

FIG. 3 is a Raman spectrum of the electrode active material of Comparative Example 3.

FIG. 4 is a graph showing the capacity at a low potential (0.05V (vs Na/Na⁺) or less) in the batteries of the respective Examples and Comparative Examples.

### DESCRIPTION OF EMBODIMENTS

Hereinafter, embodiments of the present disclosure will be described in detail. It is noted that the present disclosure is not limited to the following embodiments, and various modifications can be made within the scope of the present disclosure.

### <<Electrode Active Material>>

The electrode active material of the present disclosure comprises hard carbon. The hard carbon has a G′-band, a G-band, and a D-band in a Raman spectrum. The ratio I_{G′}/I_{G} of intensity I_{G′} of the G′-band to intensity I_{G} of the G-band is 0.05 or more. The half-width Hw_{D} of D-band is 50 or more and 160 or less.

Conventionally, measures using Raman spectroscopy have been performed to identify the structure of hard carbon. In this regard, the present disclosers have unexpectedly found that an electrode active material comprising hard carbon with a G′-band (referred to as a “2D-band” in PTL 2) of a predetermined size and a moderate half-width of a D-band in a Raman spectrum could improve the battery capacity at low potential.

Hard carbon does not have a structure in which graphene is regularly stacked like graphite, but has a structure in which graphene is irregularly aggregated. On the other hand, G′-band is attributed to the stacked structure of graphene. In other words, the fact that the electrode active material of the present disclosure has a G′-band suggests that the electrode active material of the present disclosure has a nano-stacked structure (nano-graphite structure) of graphene.

The half-width of the D-band is attributed to a structural defect of crystallite. For example, a small half-width of the D-band in an electrode active material suggests that there are a fewer structural defect of crystallite.

That is, it is presumed that an electrode active material having a nano-graphite structure and having a moderate structural defect of crystallite can improve the battery capacity at a low potential.

With respect to the present disclosure, the “electrode active material” can be used as either a “positive electrode active material” or a “negative electrode active material”, and is particularly used as a “negative electrode active material”.

The electrode active material of the present disclosure comprises hard carbon. The content of the hard carbon to the total amount of the electrode active material may be 50% by mass or more, 70% by mass or more, 90% by mass or more, 9 5% by mass or more, or 99% by mass or more, and may be 100% by mass. That is, the electrode active material may be hard carbon. The average particle size of the hard carbon is not particularly limited, but can be, for example, in the range of 50 nm to 100 μm.

Hard carbon has a G′-band, a G-band, and a D-band in a Raman spectrum.

With respect to the present disclosure, in the Raman spectrum of the electrode active material, it can be determined that peaks identified near 2800 to 2600 cm⁻¹, 1600 cm⁻¹ and 1350 cm⁻¹ are G′-band, G-band and D-band, respectively.

The ratio I_{G′}/I_{G} of intensity I_{G′} of the G′-band to intensity I_{G} of the G-band is 0.05 or more. The ratio I_{G′}/I_{G} may be 0.05 or more, 0.1 or more, 0.2 or more, or 0.3 or more, and may be 1.0 or less, 0.8 or less, 0.5 or less, or 0.4 or less. In particular, the ratio I_{G′}/I_{G} may be 0.3 or more and 0.4 or less.

Since the G′-band is attributed to the number of graphene layers, that is, the stacked structure, and the G-band is attributed to the planar structure derived from sp² orbital, I_{G′}/I_{G} means the ratio of the stacked structure to the planar structure of the electrode active material.

The half-width Hw_{D} of the D-band is 50 or more and 160 or less. The half-width Hw_{D} may be 60 or more, 70 or more, 80 or more, or 90 or more, and may be 150 or less, 140 or less, or 130 or less. In particular, the half-width Hw_{D} may be 90 or more and 130 or less.

The ratio I_{D}/I_{G} of intensity I_{D} of the D-band to intensity I_{G} of the G-band may be 1.0 or more and 1.6 or less. The ratio I_{D}/I_{G} may be 1.1 or more, or 1.2 or more, and may be 1.5 or less, or 1.4 or less. In particular, the ratio I_{D}/I_{G} may be 1.2 or more and 1.4 or less.

Since the D-band is attributed to the structure derived from sp³ orbital, and the G-band is attributed to the structure derived from sp² orbital, I_{D}/I_{G} means the ratio of the structure derived from sp² orbital of the structure derived from sp³ orbital of the electrode active material. Smaller I_{D}/I_{G} means more structure derived from sp² orbital, that is, more graphite structure, and larger I_{D}/I_{G} means fewer graphite structure.

The Raman spectrum of the electrode active material of the present disclosure can be obtained by Raman spectroscopy (wavelength 532 nm). The baseline of Raman spectrum can be set, for example, by conducting a baseline analysis by using Spectra Manager manufactured by JASCO Corporation.

The electrode active material of the present disclosure may be, for example, a material obtained by firing a commercially available product of hard carbon under an inert atmosphere, and in particular may be a material manufactured by a method for manufacturing an electrode active material described later.

### <<Manufacturing Method for Electrode Active Material>>

The method for manufacturing the electrode active material of the present disclosure comprises the following steps: providing a raw material comprising carbon, and firing to carbonize the raw material under an inert atmosphere comprising more than 0% and less than 1.0% of air.

Conventionally, a method for carbonizing a raw material comprising carbon by firing under an inert atmosphere has been generally employed. In this regard, the present disclosers have unexpectedly found that the electrode active material of the present disclosure can be obtained by firing to carbonize a raw material comprising carbon under an inert atmosphere comprising a trace amount of air. Without being limited by theory, it is believed that this is because the oxygen contained in the air preferentially performs oxidation removal to parts other than nano-graphite, thereby increasing the ratio of nano-graphite parts in the obtained carbon material.

The method of the present disclosure comprises providing a raw material comprising carbon.

The raw material comprising carbon is not particularly limited as long as it is a raw material capable of producing hard carbon. For example, the raw material comprising carbon may be organic compounds such as alcohols, such as ethanol, phenols, and aldehydes, such as formaldehyde; resins such as phenolic resins, polyacrylonitriles, and polyimides; and wood materials such as coconut shells. These raw materials may be used alone or in combination of two or more kinds.

The method of the present disclosure comprises firing to carbonize the raw material under an inert atmosphere comprising more than 0% and less than 1.0% air. In the method of the present disclosure, the ratio of air comprised in an inert atmosphere may be 0.1% or more, 0.2% or more, 0.3% or more, 0.4% or more, or 0.5% or more, and may be 0.9% or less, 0.8% or less, 0.7% or less, 0.6% or less, or 0.5% or less.

The firing temperature is not particularly limited. The firing temperature may be, for example, 1000° C. or more, 1100° C. or more, 1200° C. or more, 1300° C. or more, 1400° C. or more, or 1500° C. or more, and may be 2000° C. or less, 1900° C. or less, 1800° C. or less, 1700° C. or less, 1600° C. or less, or 1500° C. or less.

The firing time may be 0.1 hours or more, 0.5 hours or more, 1 hour or more, or 2 hours or more, and may be 5 hours or less, 4 hours or less, 3 hours or less, or 2 hours or less.

### <<Electrode Mixture>>

The electrode mixture of the present disclosure comprises the electrode active material of the present disclosure. The electrode mixture of the present disclosure may optionally comprise a conductive aid and a binder. When a battery comprising the electrode mixture of the present disclosure is a solid-state battery, the electrode mixture of the present disclosure may optionally comprise a solid electrolyte.

The “electrode mixture” relating to the present disclosure means a composition that can constitute an electrode active material layer as-is or by further containing additional components. Further, the “electrode mixture slurry” relating to the present disclosure means a slurry that comprises a dispersion medium in addition to the “electrode mixture” and can thereby be applied and dried to form an electrode active material layer.

### <Electrode Active Materials>

For the electrode active material, the above description relating to the electrode active material of the present disclosure can be referred to. The electrode mixture of the present disclosure may comprise an electrode active material in an amount of 50% by mass or more or 70% by mass or more, and 99% by mass or less, or 95% by mass or less.

### <Conductive Aid>

The conductive aid may be, for example, a carbon material, a metal material, or the like. Specific examples of the carbon material include carbon black such as acetylene black, Ketjen black, furnace black, and thermal black; carbon fibers such as VGCF; graphite; hard carbon; coke; and the like. Examples of the metallic material include Fe, Cu, Ni, Al and the like. The content of the conductive aid in the electrode mixture is not particularly limited, and may be appropriately determined according to the desired conductivity.

### <Binder>

As the binder, a chemically and electrically stable binder may be used. Specific examples of the binder include a fluorine-based binder such as a polyvinylidene fluoride (PVdF)-based binder and a polytetrafluoroethylene (PTFE)-based binder; a rubber-based binder such as a styrene-butadiene rubber (SBR)-based binder; an olefin-based binder such as a polypropylene (PP)-based binder, a polyethylene (PE)-based binder; a cellulose-based binder such as a carboxy methylcellulose (CMC)-based binder; or a polyacrylic acid (PAA)-based binder. The content of the binder in the electrode mixture is not particularly limited, and may be appropriately determined according to the desired binding property.

### <Solid Electrolyte>

The solid electrolyte may be an inorganic solid electrolyte. Examples of the inorganic solid electrolyte include an oxide solid electrolyte and a sulfide solid electrolyte. Examples of the oxide solid electrolyte include NASION-based compounds such as Na₃Zr₂Si₂PO₁₂, beta-alumina (Na₂O-11Al₂O₃) and the like. Examples of the sulfide solid electrolyte include Na₂S—P₂S₅. The solid electrolyte may be in the form of, for example, particulate.

### <<Battery>>

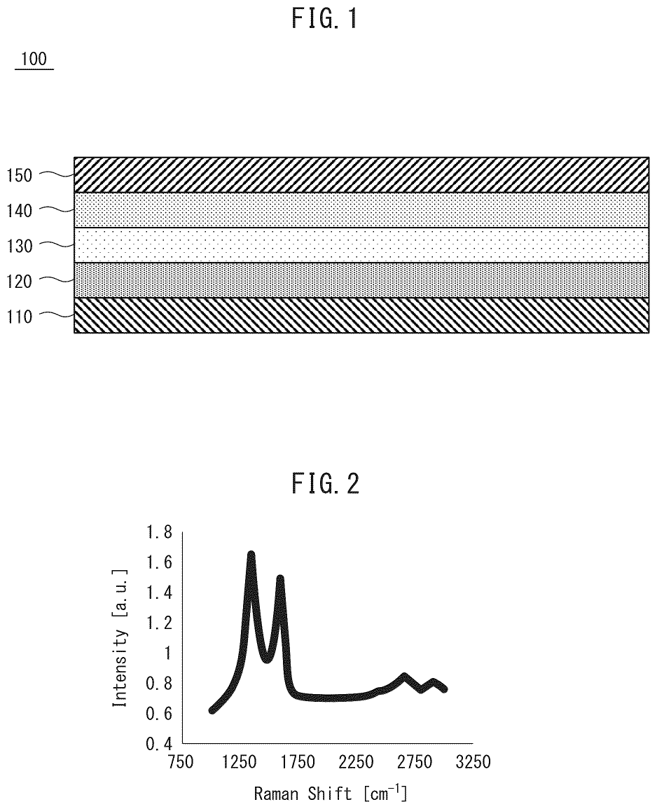

As shown in FIG. 1, the battery 100 of the present disclosure comprises a negative electrode current collector layer 110, a negative electrode active material layer 120, an electrolyte layer 130, a positive electrode active material layer 140, and a positive electrode current collector layer 150 in this order, and either one of the negative electrode active material layer and the positive electrode active material layer comprises an electrode mixture of the present disclosure.

The battery of the present disclosure may be a primary battery and a secondary battery such as a lithium ion battery and a sodium ion battery. In particular, the battery of the present disclosure may be a sodium ion battery. The electrolyte layer of the sodium ion battery may have a sodium ion.

The battery of the present disclosure may be a liquid battery or a solid-state battery. The “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte. The electrolyte layer of the liquid-based battery may comprise an electrolytic solution having a sodium ion. The electrolyte layer of the solid-state battery may comprise a solid electrolyte having a sodium ion.

Hereinafter, exemplarily, materials constituting the battery of the present disclosure when the battery of the present disclosure is a sodium ion battery will be described.

### <Negative Electrode Current Collector Layer>

Examples of the material of the negative electrode current collector layer include SUS, aluminum, copper, nickel, and carbon.

The negative electrode current collector layer may be, for example, a foil shape, a mesh shape, or a porous shape.

### <Negative Electrode Active Material Layer>

The negative electrode active material layer comprises a negative electrode mixture comprising a negative electrode active material and optionally a solid electrolyte, a conductive aid, and a binder. In particular, the negative electrode mixture may be the electrode mixture of the present disclosure. In other words, the negative electrode active material layer may comprise the electrode mixture of the present disclosure. For the electrode mixture of the present disclosure, the above description relating to the electrode mixture of the present disclosure can be referred to.

The negative electrode active material layer may have a certain thickness. The thickness of the negative electrode active material layer is not particularly limited, but may be, for example, 0.1 μm or more and 1 mm or less.

### <Electrolyte Layer>

When the battery of the present disclosure is a liquid-based battery, an electrolyte layer may be formed by impregnating the separator with an electrolytic solution.

### (Separator)

The material for the separator is not particularly limited as long as it has a function of electrically separating the negative electrode active material layer and the positive electrode active material layer, and examples thereof include a porous sheet made of a resin such as polyethylene (PE), polypropylene (PP), polyester, cellulose, or polyamide; a porous insulating material such as a nonwoven fabric or a glass fiber nonwoven fabric; or a combination thereof. The thickness of the separator is not particularly limited, and may be, for example, 5 μm or more and 1 mm or less.

### (Electrolyte)

The electrolytic solution may comprise a sodium salt and a non-aqueous solvent. Examples of the sodium salt include an inorganic sodium salt such as NaPF₆, NaBF₄, NaClO₄ and NaAsF₆; and an organic sodium salt such as NaCF₃SO₃, NaN(CF₃SO₂)₂, NaN(C₂F₅SO₂)₂, NaN(FSO₂)₂, NaC(CF₃SO₂)₃.

The non-aqueous solvent is not particularly limited as long as it dissolves the sodium salt. Examples of the high dielectric constant solvent comprise cyclic esters (cyclic carbonates) such as ethylene carbonate (EC), propylene carbonate (PC), and butylene carbonate (BC), γ-butyrolactone, sulfolane, N-methyl-2-pyrrolidone (NMP), 1,3-dimethyl-2-imidazolidinone (DMI), and the like. On the other hand, examples of the low viscosity solvent comprise chain esters (chain carbonates) such as dimethyl carbonate (DMC), diethyl carbonate (DEC), and ethyl methyl carbonate (EMC); acetates such as methyl acetate and ethyl acetate; and ethers such as 2-methyltetrahydrofuran. As the non-aqueous solvent, a mixed solvent obtained by mixing a high dielectric constant solvent and a low viscosity solvent may be used.

When the battery of the present disclosure is a solid-state battery, the electrolyte layer comprises a solid electrolyte, and may optionally comprise a conductive aid and a binder.

For the solid electrolyte, the conductive aid, and the binder, the above description relating to the electrode mixture of the present disclosure can be referred to.

### <Positive Electrode Active Material Layer>

The positive electrode active material layer comprises a positive electrode active material, and may optionally comprise a conductive aid and a binder. When the battery of the present disclosure is a solid-state battery, the positive electrode active material layer may optionally comprise a solid electrolyte.

When the negative electrode active material layer comprises the electrode mixture material of the present disclosure, examples of the positive electrode active material comprise Na-comprising oxides such as layered active materials, spinel-type active materials, and olivine-type active materials. Specifically, examples of the positive electrode active material comprise such as NaFeO₂, NaNiO₂, NaCoO₂, NaMnO₂, NaVO₂, Na(Niₓ Mn₁₋ₓ)O₂ (0<X<1), Na(Feₓ Mn₁₋ₓ) O₂ (0<X<1), NaVPO₄ F, Na₂ FePO₄ F, Na₃ V₂ (PO₄)₃. The shape of the positive electrode active material is not particularly limited. The positive electrode active material may be particulate. In this case, the average particle size may be, for example, 1 nm or more or 10 nm or more, and may be 100 μm or less or 30 μm or less. As the content of the positive electrode active material in the positive electrode active material layer increases, the capacity of the positive electrode increases. The positive electrode active material layer may comprise the positive electrode active material in an amount of, for example, 50% by mass or more or 70% by mass or more, and 99% by mass or less or 95% by mass or less.

For the conductive aid, binder, and solid electrolyte, the above description relating to the electrode mixture of the present disclosure can be referred to.

The positive electrode active material layer may have a certain thickness. The thickness of the positive electrode active material layer is not particularly limited, but may be, for example, 0.1 μm or more and 1 mm or less.

### <Positive Current Collector Layer>

Examples of the material for the positive electrode current collector comprise SUS, aluminum, nickel, iron, titanium, and carbon.

The positive electrode current collector may be, for example, a foil shape, a mesh shape, or a porous shape.

It is note that, for example, when the battery of the present disclosure is a battery other than a sodium ion battery, various materials commonly used in such batteries can be used.

### <Other Configurations>

The battery of the present disclosure may comprise a battery case, which houses each layer of the battery, and a terminal connected to a current collector. The battery of the present disclosure may also comprise a restraining member that restrains each layer along the laminated direction to reduce contact resistance. For these, the same ones as conventional ones may be used.

Examples of the shape of the battery of the present disclosure comprise a coin form, a laminate form, a cylindrical form, and an angular form.

### <<Method for Manufacturing Battery>>

The method for manufacturing the battery of the present disclosure may comprise forming an electrode active material layer comprising an electrode mixture of the present disclosure.

A method of forming an electrode active material layer may comprise providing an electrode mixture slurry comprising the electrode mixture of the present disclosure and a dispersion medium, and applying the electrode mixture slurry to a substrate and drying and removing the dispersion medium.

For electrode mixture, the above description regarding to the electrode mixture of the present disclosure can be referred to.

The dispersion medium is not particularly limited, and examples thereof comprise alcohols, glycols, cellosolves, amines, ketones, carboxylic acid amides, phosphoric acid amides, sulfoxides, carboxylic acid esters, phosphoric acid esters, ethers, and nitriles. Specific examples thereof comprise ethanol, 2-propanol, methyl ethyl ketone, and N-methyl-2-pyrrolidone.

The substrate is not particularly limited, but may be, for example, a negative electrode current collector layer when the negative electrode active material layer comprises the electrode mixture of the present disclosure.

The drying temperature, the drying time, and the like can be appropriately designed depending on the boiling point and the amount used of the dispersion medium.

### EXAMPLES

### <<Production Example 1>>

### <Production for Electrode Active Material>

A commercially available spherical phenolic resin as a raw material comprising carbon was fired to carbonize at 1500° C. for 2 hours under an argon atmosphere mixed with 0.5% of air to produce hard carbon. Thus, an electrode active material of Production Example 1 was obtained.

### <<Manufacturing Example 2>>

An electrode active material of Production Example 2 was obtained in the same manner as in Production Example 1, except that a commercially available coconut shell chip was used as a raw material comprising carbon.

### <<Manufacturing Example 3>>

KURANODE (manufactured by Kuraray Co., Ltd.) as a carbon material was fired at 2000° C. under an argon atmosphere. Thus, an electrode active material of Production Example 3 was obtained.

### <<Comparative Production Example 1>>

Carbotron P S (F) (manufactured by Kureha Co., Ltd.) as a carbon-material was fired at 1200° C. under an argon atmosphere. Thus, an electrode active material of Comparative Production Example 1 was obtained.

### <<Comparative Manufacturing Example 2>>

An electrode active material of Comparative Production Example 2 was obtained in the same manner as in Comparative Production Example 1 except that the firing temperature was set at 1500° C.

### Example 1

### <Preparation of Positive Electrode Mixture>

The electrode active material of Production Example 1 as a negative electrode active material and polyvinylidene fluoride (PVdF) as a binder were dispersed in N-methyl-2-pyrrolidone (NMP) so as to be 95:5 by mass, and these were stirred and mixed at 2000 rpm for 10 minutes. Thereby, a slurry-like electrode mixture (electrode mixture slurry) as a negative electrode mixture was obtained.

### <Formation of Electrode Active Material Layer>

The obtained electrode mixture slurry was applied onto an aluminum (Al) current collector foil as a negative electrode current collector layer using a bar coater of 75 μm, and was then dried at 80° C. for 30 minutes. A laminated body of the negative electrode current collector layer and the dried electrode mixture was punched out to a diameter of φ16 mm, and then compression molded by a press machine so that the electrode density became 1.0 g/cc. Thus, an electrode active material layer as a negative electrode active material layer was formed on the negative electrode current collector layer.

### <Preparation of Evaluation Cell>

A 2032-type coin cell was prepared using a negative electrode which is the laminated body of the negative electrode current collector layer, and the electrode active material layer as a negative electrode active material layer, a metallic sodium (Na) as a counter electrode, a 50 μm glass separator as a separator, and 1M NaPF₆ EC: DMC=1:1 (volume ratio) as an electrolyte solution.

### <<Evaluation>>

### <Measurement by Raman Spectroscopy>

The Raman spectrum of each Example was obtained by Raman spectrometry (wavelength 532 nm). The baseline of Raman spectrum was set by conducting a baseline analysis by using Spectra Manager manufactured by JASCO Corporation.

### <Charge-Discharge Test>

A charge-discharge test was conducted in an environment of 25° C. with a voltage range of 0.01 V-1.5 V and a current value of 0.1 C to evaluate Na insertion capacity (charge capacity) and Na desorption capacity (discharge capacity) of the coin cell. Among the obtained Na insertion capacities, the low potential capacity, that is, the capacity at 0.05-0.01V (vs. Na/Na⁺) was calculated and defined the capacity below 0.05V (vs. Na/Na⁺).

### Examples 2 to 4 and Comparative Examples 1 to 5

In the process of preparing the electrode mixture, the evaluation cells of Examples 2 to 4 and Comparative Examples 1 to 5 were obtained and evaluated in the same manner as in Example 1, except that the type of the electrode active material was changed as in Table 1

### <<Results>>

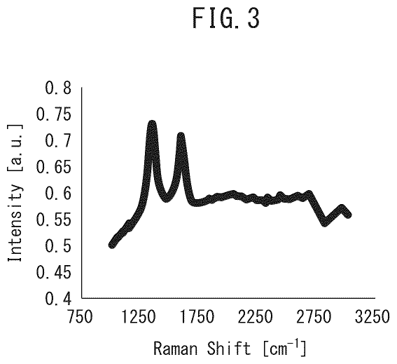

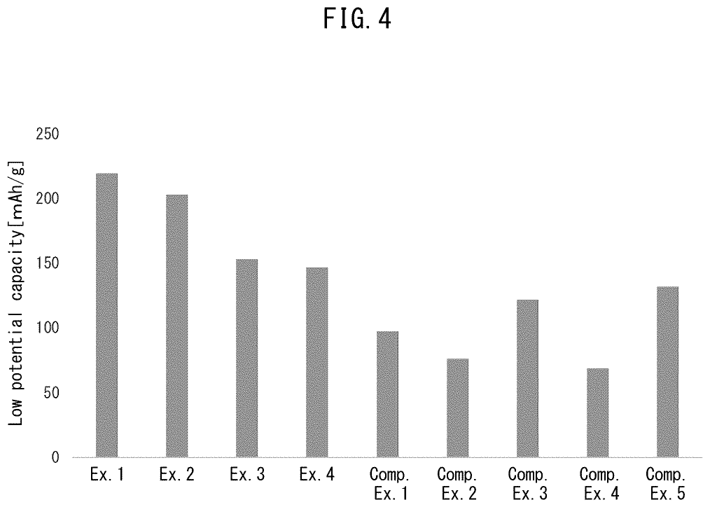

The Raman spectra of Example 1 and Comparative Example 3 obtained by Raman spectroscopy are shown in FIGS. 2 and 3 (FIG. 2: Example 1, FIG. 3: Comparative Example 3). The ratio I_{G′}/I_{G} of intensity I_{G′} of the G′-band to intensity I_{G} of the G-band on the basis of Raman spectrum I_{G′}/I_{G}, the half-width Hw_{D} of the D-band, and the ratio I_{D}/I_{G} of intensity I_{D} of the D-band to intensity I_{G} of the G-band are shown in Table 1. In addition, the results of the charge-discharge test are shown in Table 1 and FIG. 4.

TABLE 1

| | | | | | low potential capacity |
|---|---|---|---|---|---|
| | electrode active material | I_{G}/I_{G} | Hw_{D} | I_{D}/I_{G} | [mAh/g] |
| Example 1 | Production Example 1 | 0.31 | 121 | 1.4 | 219 |
| Example 2 | Production Example 2 | 0.36 | 99 | 1.2 | 203 |
| Example 3 | Carbotron P (J) type | 0.47 | 158 | 1.1 | 153 |
| | (manufactured by Kureha Co., Ltd.) | | | | |
| Example 4 | Production Example 3 | 0.83 | 58 | 1.5 | 147 |
| Comparative | BTR300 | — | 116 | 1.2 | 97 |
| Example 1 | (manufactured by Tianjin BTR New Energy Materials) | | | | |
| Comparative | Comparative Production Example 1 | — | 117 | 1.2 | 76 |
| Example 2 | | | | | |
| Comparative | Comparative Production Example 2 | — | 85 | 1.3 | 122 |
| Example 3 | | | | | |
| Comparative | KURANODE | — | 143 | 1.2 | 69 |
| Example 4 | (manufactured by Kuraray Co., Ltd.) | | | | |
| Comparative | BELLFINE | — | 127 | 1.2 | 132 |
| Example 5 | (manufactured by AT electrode Co., Ltd.) | | | | |

As shown in FIG. 2, it was confirmed that the electrode active material of the present disclosure according to the Examples has a G′-band near 2800 to 2600 cm⁻¹ in the Raman spectrum. In contrast, in the electrode active material according to the Comparative Examples, the G′-band was not confirmed in the Raman spectrum.

As shown in Table 1 and FIGS. 4, in the cells of Examples in which the I_{G′}/I_{G}, and the half-width Hw_{D} of the D-band were within the ranges of the present disclosure, the capacity at a low potential was large. In particular, in the cells of Examples 1 and 2 in which the half-width Hw_{D} was 90 or more and 130 or less, the capacity at a low potential was even larger.

### DESCRIPTION OF REFERENCE SIGNS

100 Battery
110 Negative electrode current collector layer
120 Negative electrode active material layer
130 Electrolyte layer
140 Positive electrode active material layer
150 Positive electrode current collector layer

1. An electrode active material comprising hard carbon,
wherein the hard carbon has a G′-band, a G-band, and a D-band in a Raman spectrum,
wherein a ratio I_{G′}/I_{G} of intensity I_{G′} of the G′-band to intensity I_{G} of the G-band is 0.05 or more, and
wherein a half-width Hw_{D} of the D-band is 50 or more and 160 or less.

2. The electrode active material according to claim 1, wherein the half-width Hw_{D} of the D-band is 90 or more and 130 or less.

3. The electrode active material according to claim 1, wherein the ratio I_{D}/I_{G} of intensity I_{D} of the D-band to intensity I_{G} of the G-band is 1.0 or more and 1.6 or less.

4. The electrode active material according to claim 3, wherein the ratio I_{D}/I_{G} of intensity I_{D} of the D-band to intensity I_{G} of the G-band is 1.2 or more and 1.4 or less.

5. An electrode mixture comprising the electrode active material according to claim 1.

6. A battery,
wherein the battery comprises a negative electrode current collector layer, a negative electrode active material layer, an electrolyte layer, a positive electrode active material layer, and a positive electrode current collector layer in this order,
wherein either one of the negative electrode active material layer and the positive electrode active material layer comprises the electrode mixture according to claim 5.

7. The battery according to claim 6, wherein the negative electrode active material layer comprises the electrode mixture according to claim 5.

8. The battery according to claim 6, wherein the battery is a sodium ion battery in which the electrolyte layer has a sodium ion.

9. The battery according to claim 8, wherein the battery is a liquid-based battery in which the electrolyte layer comprises an electrolytic solution having a sodium ion.

10. The battery according to claim 8, wherein the battery is a solid-state battery in which the electrolyte layer comprises a solid electrolyte having a sodium ion.

11. A method for manufacturing an electrode active material according to claim 1, comprising the following steps:
providing a raw material comprising carbon, and
firing to carbonize the raw material under an inert atmosphere comprising more than 0% and less than 1.0% of air.
